(19) United States
(12) Patent Application Publication
(10) Pub. No.: US 2024/0340700 A1
(43) Pub. Date: Oct. 10, 2024

(54) Multi-Access Point Offloading Based on Traffic Category

(71) Applicant: Ofinno, LLC, Reston, VA (US)

(72) Inventors: Kazi Mohammed Saidul Huq, Herndon, VA (US); Jeongki Kim, Fairfax, VA (US); Esmael Hejazi Dinan, McLean, VA (US); Leonardo Alisasis Lanante, Reston, VA (US); Tuncer Baykas, Reston, VA (US)

(73) Assignee: Ofinno, LLC, Reston, VA (US)

(21) Appl. No.: 18/623,094

(22) Filed: Apr. 1, 2024

Related U.S. Application Data
(60) Provisional application No. 63/457,819, filed on Apr. 7, 2023.

(51) Int. Cl. H04W 28/086; H04W 28/02

(52) U.S. Cl. CPC H04W 28/086; H04W 28/0268

(57) ABSTRACT

A first access point (AP) receives first data for a first station (STA) and, based on the first data being of a first category, transmits the first data to a second AP for transmission by the second in a first physical layer protocol data unit (PPDU) to the first STA. The first AP receives, during or before transmission of the first PPDU, second data for a second STA, and transmits, to the second STA, a second PPDU, overlapping the first PPDU, comprising the second data.

### CROSS-REFERENCE TO RELATED APPLICATIONS

This application claims the benefit of U.S. Provisional Application No. 63/457,819, filed Apr. 7, 2023, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example multi-AP network.

FIG. 4 illustrates Enhanced Distributed Channel Access (EDCA) and Coordinated Orthogonal Frequency Division Multiple Access (COFDMA).

FIG. 5 illustrates an example network that includes a coordinated AP set.

FIG. 6 illustrates an example multi-AP operation procedure.

FIG. 7 illustrates an example multi-AP sounding phase.

FIG. 8 illustrates an example multi-AP downlink data transmission phase.

FIG. 9 illustrates an example multi-AP uplink data transmission phase.

FIG. 10 illustrates an example of a trigger frame format.

FIG. 11 is an example that illustrates a potential problem that arises in an existing transmission procedure in a multi-AP environment.

FIG. 12 illustrates an example of a multi-AP offloading scheme according to an embodiment.

FIG. 13 illustrates an example of another multi-AP offloading scheme according to an embodiment.

FIG. 14 illustrates an example trigger frame which may be used in embodiments.

FIG. 15 illustrates an example process according to an embodiment.

FIG. 16 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

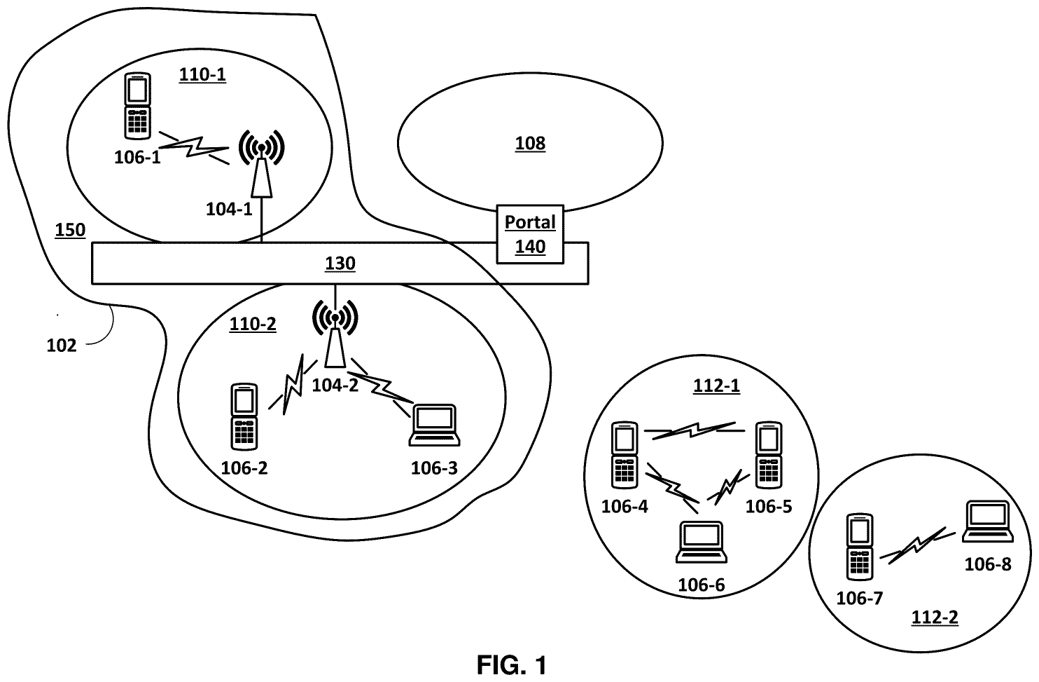

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHZ, 160 MHz, or 520 MHz by bonding together multiple 20 MHz channels.

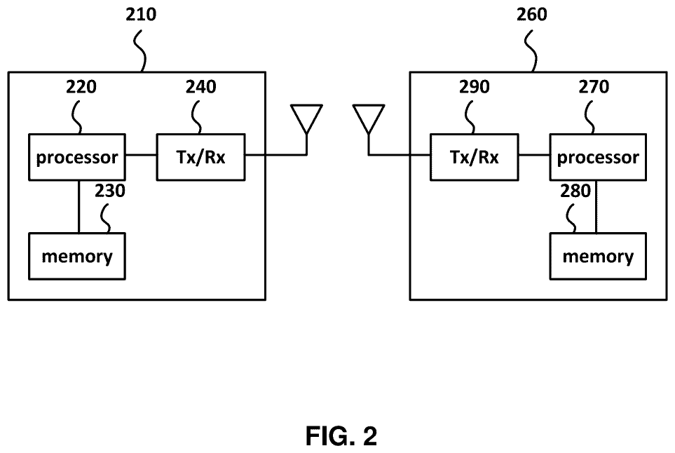

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

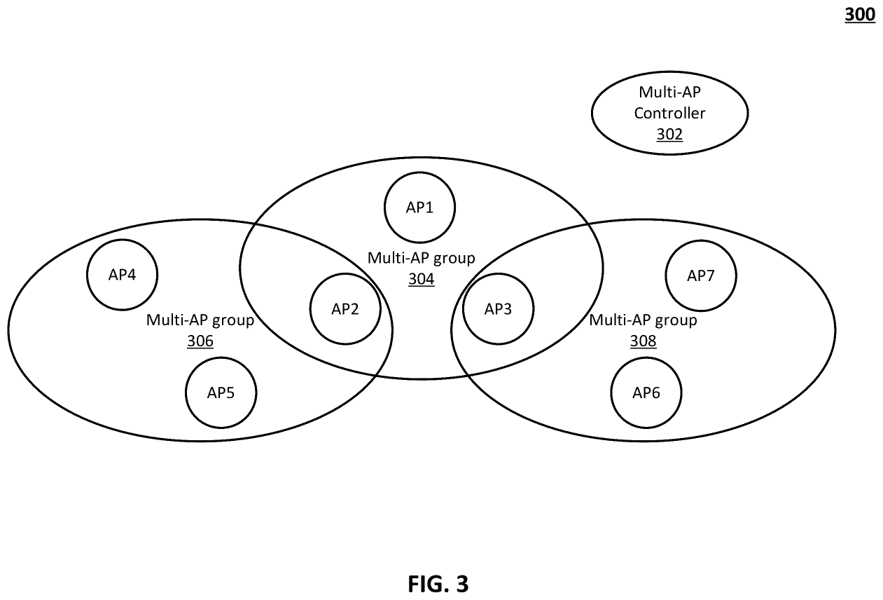

FIG. 3 illustrates an example multi-AP network 300. Example multi-AP network 300 may be a multi-AP network in accordance with the Wi-Fi Alliance standard specification for multi-AP networks. As shown in FIG. 3, multi-AP network 300 may include a multi-AP controller 302 and a plurality of multi-AP groups (or multi-AP sets) 304, 306, and 308.

Multi-AP controller 302 may be a logical entity that implements logic for controlling the APs in multi-AP network 300. Multi-AP controller 302 may receive capability information and measurements from the APs and may trigger AP control commands and operations on the APs. Multi-AP controller 302 may also provide onboarding functionality to onboard and provision APs onto multi-AP network 300.

Multi-AP groups 304, 306, and 308 may each include a plurality of APs. APs in a multi-AP group are in communication range of each other and may coordinate their transmissions and/or transmissions from their associated STAs. Coordinated transmissions may involve all or a subset of the APs in a multi-AP group. A multi-AP group may also be referred to as an AP candidate set as APs in a multi-AP group are considered candidates for a coordinated transmission initiated by an AP. The APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, a multi-AP group may be established by a coordinator AP in a multi-AP setup phase prior to any multi-AP coordination. APs of the multi-AP group, other than the coordinator AP, may be referred to as the coordinated APs. A coordinator AP may establish one or more multi-AP groups. A coordinated AP may likewise be a member of multiple multi-AP groups. A coordinator AP of a multi-AP group may be a coordinated AP of another multi-AP group, and vice versa. In another approach, a multi-AP group may be established by a network administrator manually by configuring APs as part of the multi-AP group. In yet another approach, a multi-AP group may be established in a distributed manner by APs without a central controller. In this case, an AP may advertise its multi-AP capability in a beacon or other management frame (e.g., public action frame). Other APs that receive the frame with the multi-AP capability information may perform a multi-AP setup with the AP that advertised the multi-AP capability.

In one approach, one of the APs in a multi-AP group may be designated as a master AP. The designation of the master AP may be done by AP controller 302 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may perform coordinated transmissions together. One aspect of coordination may include coordination to perform coordinated transmissions within the multi-AP group. As used herein, a coordinated transmission, also referred to as a multi-AP transmission, is a transmission event in which multiple APs (of a multi-AP group or a multi-AP network) transmit in a coordinated manner over a time period. Coordinated transmissions may involve simultaneous transmissions of a plurality of APs in a multi-AP group. The time period of simultaneous AP transmission may be a continuous period. The multi-AP transmission may use different transmission techniques, such as Coordinated OFDMA (COFDMA), Coordinated Spatial Reuse (CSR), Joint Transmission or Reception (JT/JR), Coordinated Beamforming (CBF), and CTDMA, or a combination of two or more of the aforementioned techniques.

Multi-AP transmissions may be enabled by the AP controller and/or by the master AP of the multi-AP group. In one approach, the AP controller and/or the master AP may control time and/or frequency sharing in a transmission opportunity (TXOP). For example, when one of the APs (e.g., the master AP) in the multi-AP group obtains a TXOP, the AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Different multi-AP transmission schemes may be suitable for different use cases in terms of privacy protection, including whether transmitted data may be shared with other BSSs in the multi-AP group. For example, some multi-AP transmission schemes, such as CSR, CDTMA, coordinated frequency division multiple access (CFDMA), COFDMA, and CBF, enable a master AP to coordinate slave APs by sharing control information among APs, without requiring the sharing of user data among APs. The control information may include BSS information of APs, link quality information of channels between each AP and its associated STAs, and information related to resources to be used to achieve multiplexing in power, time, frequency, or special domains for multi-AP transmission. The control information exchanged among a master AP and slave APs may be used for interference avoidance or nulling to avoid or null co-channel interference introduced to neighboring BSSs in a multi-AP network. Interference avoidance or interference nulling requires that data transmissions between an AP and STAs are only within the same BSS. In other words, each AP transmits or receives data frames to or from its associated STAs, while each STA receives or transmits data frames to or from its associating AP.

By contrast, other multi-AP transmission schemes may enable a master AP to coordinate slave APs by sharing both control information and user data among APs in a multi-AP group. Control information may include BSS information related to APs and link quality information of channels between each AP and its associated STAs. By having user data exchanged over backhaul, the master AP and slave APs may perform data transmissions jointly to achieve spatial diversity, e.g., using distributed MIMO, for example, joint transmission (JT) for downlink transmissions and joint reception (JR) for uplink transmissions. The data transmissions between APs and STAs may include transmissions within the same BSS and/or across different BSSs. In other words, an AP may transmit or receive data frames to or from its associated STAs as well STAs associated with other APs participating in multi-AP transmission. Similarly, a STA may transmit or receive data frames to or from multiple APs.

Different multi-AP transmission schemes may be suitable for different use cases in terms of signal reception levels at STAs or APs within a multi-AP group. For example, CBF and JT/JR require that each STA involved in a multi-AP transmission be located within a common area of signal coverage of the APs involved in the multi-AP transmission. Generally, CBF may be suitable when a receiving STA suffers from potential interference from other APs in the multi-AP group. By using channel related information such as channel state information (CSI), channel quality indication (CQI), or compressed beamforming (BF) feedback exchanged among APs, an AP may pre-code a signal to be transmitted to form a beam that increases power toward a target STA while reducing the power that interferes with a STA associated with a neighboring AP. Use cases of JT/JR may require a sufficient received signal power at receiving STAs for JT and a sufficient received signal power at receiving APs for JR. By contrast, CSR may perform multi-AP transmission in an interference coordination manner. The received signal power at a STA associated with an AP transmitting data may be required to be much higher than the received interference power.

Different multi-AP transmission schemes may require different synchronization levels and may operate with or without a backhaul between a master AP and slave APs in a multi-AP group. For example, CSR may require PPDU-level synchronization, whereas CBF may require symbol-level synchronization. On the other hand, JT/JR may require tight time/frequency/phase-level synchronization as well as a backhaul for data sharing between APs in the multi-AP group.

Different multi-AP transmission schemes may have different complexity levels with regard to coordination between a master AP and slave APs in a multi-AP group. For example, JT/JR may require very high complexity due to both CSI and user data being shared between APs. CBF may require medium complexity due to the sharing of CSI. CFDMA, COFDMA and CTDMA may require medium or relatively low complexity due to the CSI and time/frequency resources to be shared between APs. CSR may require low complexity as the amount of information related to spatial reuse and traffic that needs to be exchanged between APs may be low.

A multi-AP group may adopt a static multi-AP operation including a static multi-AP transmission scheme. A multi-AP network may also be dynamic due to various reasons. For example, a STA may join or leave the multi-AP network, a STA may switch to a power save mode, or an AP or a STA may change its location. Such changes may lead to changes in the conditions underlying the selection of the multi-AP transmission scheme and may cause certain requirements (e.g., synchronization, backhaul, coordination, etc.) for the multi-AP transmission scheme to be lost. This results in an inferior quality of transmissions in the multi-AP network.

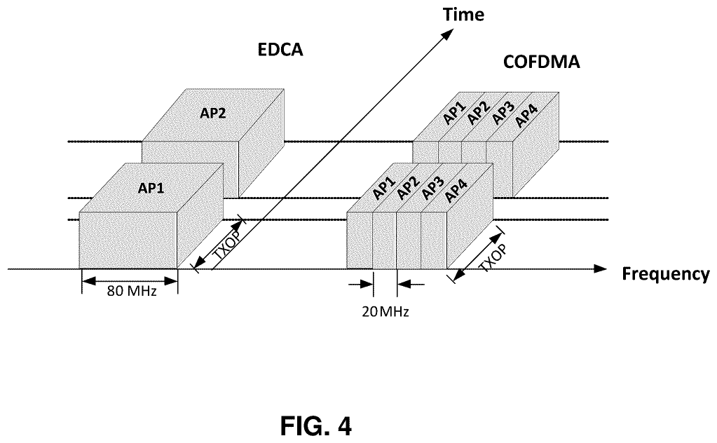

In COFDMA, the master AP may share a portion of its TXOP with multiple APs by assigning each of the multiple APs a respective frequency resource (e.g., channel/subchannel) of available frequency resources. COFDMA is illustrated in FIG. 4 as a multi-AP channel access, compared with Enhanced Distributed Channel Access (EDCA). As shown in FIG. 4, in EDCA, channel access by multiple APs (e.g., AP1, AP2) may occur in consecutive time periods (e.g., TXOPs). During a given channel access, the channel (e.g., 80 MHZ) in its entirety may be used by a single AP. In contrast, in COFDMA, access by multiple APs (multi-AP channel access) may take place in a same time period (e.g., same TXOP or same portion of a TXOP) over orthogonal frequency resources. For example, as shown in FIG. 4, an 80 MHZ channel may be divided into four non-overlapping 20 MHz channels, each assigned to a respective AP of the multiple APs. The multiple APs may transmit in a coordinated manner, simultaneously in the same time period, to achieve a multi-AP transmission. In the multi-AP transmission, each of the multiple APs may transmit a PPDU to one or more STAs.

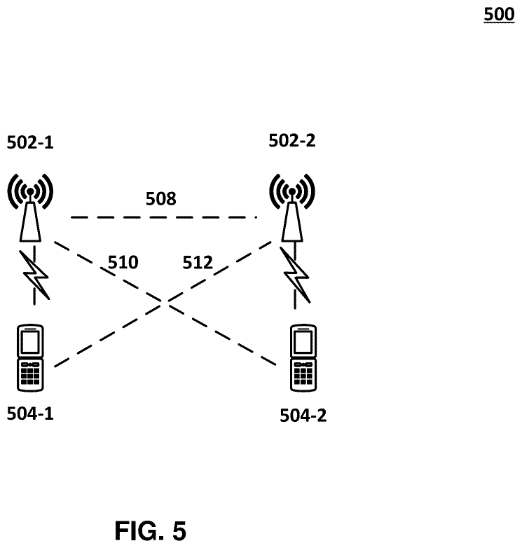

FIG. 5 illustrates an example network 500 that includes a coordinated AP set. As shown in FIG. 5, the coordinated AP set may include two APs-AP 502-1 and AP 502-2. The coordinated AP set may be a subset of an established multi-AP group. At least one STA may be associated with each of APs 502-1 and 502-2. For example, a STA 504-1 may be associated with AP 502-1, and a STA 504-2 may be associated with AP 502-2.

APs 502-1 and 502-2 may belong to the same ESS as described above in FIG. 1. In such a case, APs 502-1 and 502-2 may be connected by a DS to support ESS features. In addition, as part of a coordinated AP set, APs 502-1 and 502-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 502-1 and 502-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 5, if AP 502-1 supports JT and CSR while AP 502-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 501-1 and AP 502-2 as shown in FIG. 5. Spatial reuse using CSR can be more stable than non-AP coordinated spatial reuse schemes such as overlapping basic service set (OBSS) PD-based SR and PSR-based SR. For example, in example network 500, APs 502-1 and 502-2 may perform a joint sounding operation in order to measure path loss (PL) on paths of network 500. For example, the joint sounding operation may result in the measurement of PL 508 for the path between APs 502-1 and 502-2, path loss 510 for the path between AP 502-1 and STA 504-2, and path loss 512 for the path between AP 502-2 and STA 504-1. The measured path loss information may then be shared between APs 502-1 and 502-2 (e.g., using the backhaul) to allow for simultancous transmissions by APs 502-1 and 502-2 to their associated STAs 504-1 and 504-2 respectively. Specifically, one of APs 502-1 and 502-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

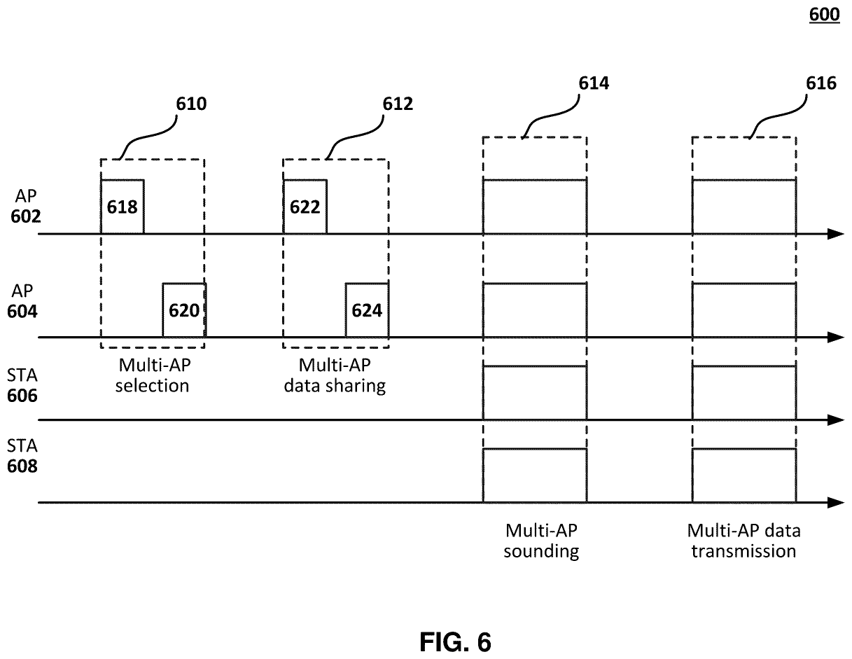

FIG. 6 illustrates an example 600 of a multi-AP operation procedure. In example 600, the multi-AP operation procedure is illustrated with respect to a multi-AP network that includes APs 602 and 604 and STAs 606 and 608. In an example, APs 602 and 604 may form a multi-AP group. AP 602 may be the master AP and AP 604 may be a slave AP of the multi-AP group. For example, AP 602 may obtain a TXOP making it the master AP of the multi-AP group. Alternatively, AP 602 may be designated as the master AP by a multi-AP controller.

As shown in FIG. 6, the multi-AP operation procedure may include a series of phases in time, each of which may contain a plurality of frame exchanges within the multi-AP network. Specifically, the multi-AP operation procedure may include a multi-AP selection phase 610, a multi-AP data sharing phase 612, a multi-AP sounding phase 614, and a multi-AP data transmission phase 616.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 610 may include procedures for soliciting, selecting, or designating slave AP(s) for a multi-AP group by a master AP. As seen in FIG. 6, the multi-AP selection phase may include transmissions of frame 618 from AP 602 and frame 620 from AP 604. AP 602 may transmit frame 618 to solicit information regarding the buffer status of AP 604. In response, AP 604 may transmit frame 620 to inform AP 602 of its and its associated STAs buffer status and/or whether it intends to join multi-AP operation. Multi-AP selection phase 610 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 612 may include procedures for sharing data frames to be transmitted by APs to associated STAs among the master AP and selected slave AP(s) via direct connections between APs. Phase 612 may be optional for some multi-AP data transmission schemes. For example, phase 612 may be required for JT/JR as data frames may be exchanged between APs before or after multi-AP data transmission phase 616.

Multi-AP data sharing phase 612 may be performed using a wired backhaul, an in-channel wireless backhaul, or an off-channel wireless backhaul. In some cases, multi-AP data sharing phase 612 may be performed over an in-channel backhaul, e.g., using the same wireless channel used to transmit/receive data to/from STAs. For example, as shown in FIG. 6, in phase 612, AP 602 may transmit a frame 622, which may be received by AP 604. Frame 622 may include MPDUs that AP 602 wishes to transmit to associated STAs using a multi-AP operation. Similarly, AP 604 may transmit a frame 624, which may be received by AP 602. Frame 624 may include MPDUs that AP 604 wishes to transmit to associated STAs using a multi-AP operation.

Multi-AP sounding phase 614 may include procedures for multi-AP channel sounding, including channel estimation and feedback of channel estimates among the master AP, candidate slave AP(s), and associated STAs. Phase 614 may be optional for some multi-AP transmission schemes, such as COFDMA, CDTMA, and CSR. For example, phase 614 may be performed by the master AP to aid in resource unit allocation when orchestrating a COFDMA transmission.

Multi-AP data transmission phase 616 may include exchange of data frames between the master AP, slave AP(s), and their associated STAs based on multi-AP transmission scheme(s) determined by the master AP. Depending on the multi-AP transmission scheme(s) to be used, phase 616 may include optional synchronization between APs of the multi-AP group, before exchange of data frames between APs and STAs within the multi-AP group.

The order of phases 610, 612, 614 and 616 may be different than shown in FIG. 6. For example, in COFDMA, phase 616 may occur immediately after phase 610, whereas, in JT/JR, phase 612 may occur after phase 610. Further, as mentioned above, some phases may be optional and may or may not be present. For example, phase 614 may not be required for COFDMA but may be required for JT/JR.

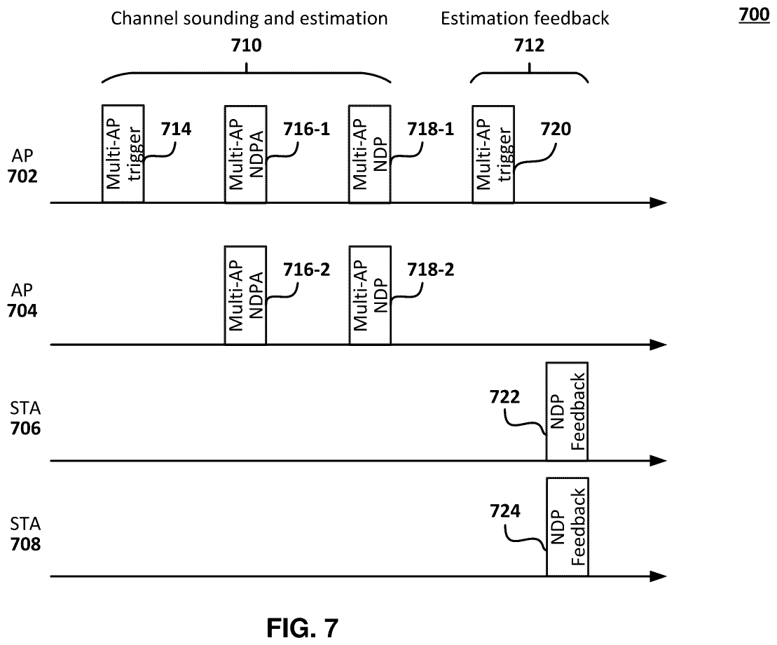

FIG. 7 illustrates an example 700 of a multi-AP sounding phase. Multi-AP sounding phase 700 may be an example of multi-AP sounding phase 614. As shown in FIG. 7, example 700 may include a master AP 702 and a slave AP 704 of a multi-AP group. Example 700 may further include a STA 706 associated with AP 702 and a STA 708 associated with AP 704.

As shown in FIG. 7, multi-AP sounding phase 700 may include frame exchanges to allow AP 702 (the master AP) to acquire channel state information (CSI) of channels in the multi-AP group. In an implementation, phase 700 may include a first subphase 710 and a second subphase 712.

During the first subphase 710, APs may initiate channel sounding and STAs may estimate channel state information (CSI). For example, AP 702 may transmit a frame 714 to AP 704 (the slave AP) to trigger multi-AP sounding. Frame 714 may comprise a multi-AP trigger frame. Subsequently, APs 702 and 704 may transmit respectively announcement frames 716-1 and 716-2 to their respective associated STAs 706 and 708 to announce the transmission of sounding frames. Frames 716-1 and 716-2 may comprise multi-AP null data packet announcement (NDPA) frames. Frames 716-1 and 716-2 may be transmitted simultaneously. Next, APs 702 and 704 may transmit respectively frames 718-1 and 718-2 to STAs 706 and 708 respectively. Frames 718-1 and 718-2 may comprise multi-AP null data packet (NDP) frames. STAs 706 and 708 receive frames 718-1 and 718-2 respectively and perform channel estimation of the channels from AP 702 to STA 706 and from AP 704 to STA 708, respectively.

During the second subphase 712, APs may initiate a procedure for STAs to feed back channel estimates to the APs. For example, AP 702 may transmit a frame 720 to trigger STAs 706 and 708 to transmit their channel estimates to APs 702 and 704 respectively. Frame 720 may comprise a multi-AP trigger frame. In response, STAs 706 and 708 may transmit respectively frames 722 and 724 including feedback of channel estimates to APs 702 and 704 respectively. Frames 722 and 724 may comprise NDP feedback frames. The feedback of channel estimates may include NDP feedback, CSI-related information, a beamforming report (BFR), or a channel quality indication (CQI) report.

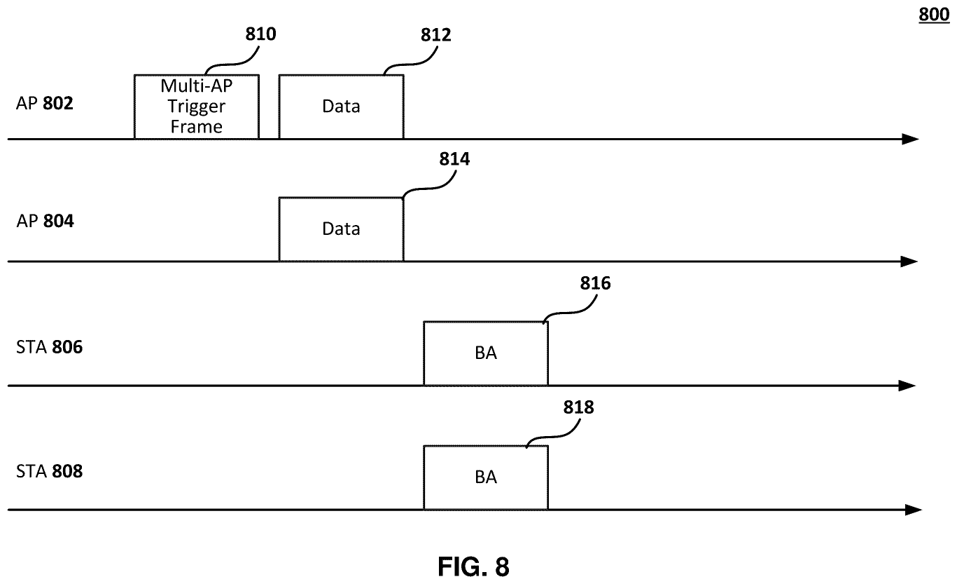

FIG. 8 illustrates an example 800 of a multi-AP downlink data transmission phase. Multi-AP downlink data transmission phase 800 may be an example of multi-AP data transmission phase 616. As shown in FIG. 8, example 800 may include a master AP 802 and a slave AP 804 of a multi-AP group. Example 800 may further include a STA 806 associated with AP 802, and a STA 808 associated with AP 804.

As shown in FIG. 8, multi-AP downlink data transmission phase 800 may include frame exchanges to enable master AP 802 to coordinate with slave AP 804 to perform specific multi-AP transmission schemes with their associated STAs 804 and 814 respectively. The multi-AP transmission schemes may include COFDMA, CTDMA, CSR, CBF, JT/JR, or a combination of two or more of the aforementioned schemes.

As shown in FIG. 8, master AP 802 may begin phase 800 by transmitting a frame 810 to AP 804. Frame 810 may include information related to AP 804 (e.g., an identifier of AP 804), synchronization information, information related to a specific multi-AP transmission scheme to be used, and/or information related to a resource unit (RU) for use by AP 804 to acknowledge frame 810. Frame 810 may comprise a control frame. For example, frame 810 may comprise a multi-AP trigger frame.

Slave AP 804 may receive frame 810 and may use the synchronization information to synchronize with master AP 802. Subsequently, APs 802 and 804 may perform data transmission to their associated STAs 806 and 808 respectively. Specifically, AP 802 may transmit a data frame 812 to its associated STA 806, and AP 804 may transmit a data frame 814 to its associated STA 808. Depending on the multi-AP transmission scheme being used, APs 802 and 804 may transmit frames 812 and 814 respectively to STAs in different BSSs. For example, when the multi-AP transmission scheme is JT/JR, AP 802 may also transmit frame 812 to STA 808 associated with slave AP 804, and AP 804 may also transmit frame 814 to STA 808 associated with AP 804. The resources for transmitting and receiving frames 812 and 814 may depend on the specific multi-AP transmission scheme adopted.

STAs 806 and 808 may acknowledge frames 812 and 814 respectively. For example, STA 806 may transmit a frame 816 to AP 802, and STA 808 may transmit a frame 818 to AP 804. Frames 816 and 818 may comprise block ack (BA) frames. STAs 804 and 814 may also transmit frames 816 and 818 to APs in different BSSs, when required by the used multi-AP transmission scheme. For example, when the multi-AP transmission scheme is JT/JR, STA 806 may also transmit frame 816 to AP 804, and STA 808 may also transmit frame 818 to AP 802. The resources for transmitting and receiving frames 816 and 818 may depend on the specific multi-AP transmission scheme adopted.

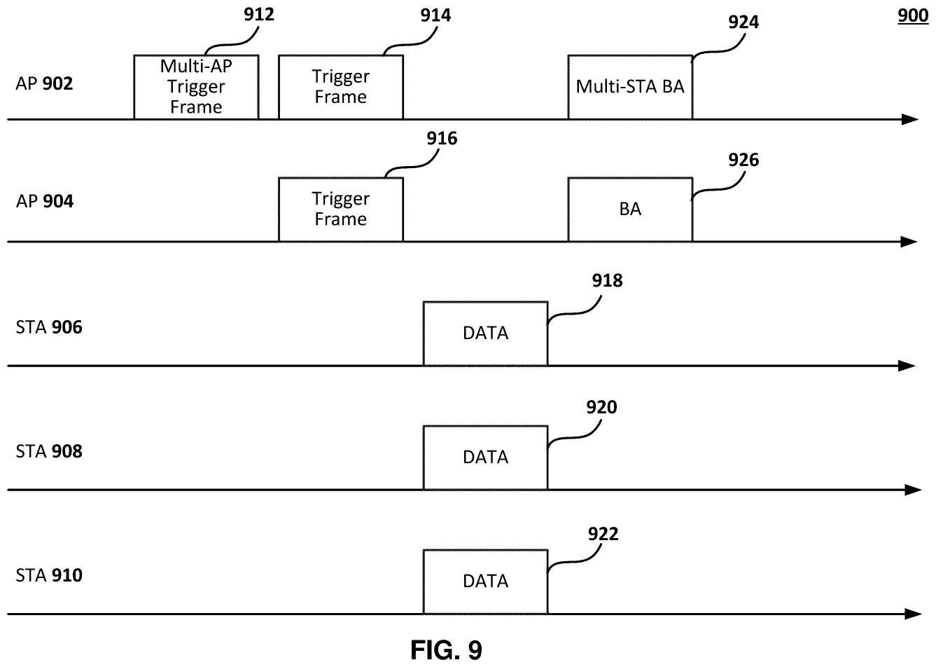

FIG. 9 illustrates an example 900 of a multi-AP uplink data transmission phase. Multi-AP uplink data transmission phase 900 may be an example of multi-AP data transmission phase 616. As shown in FIG. 9, example 900 may include a master AP 902 and a slave AP 904 of a multi-AP group. Example 900 may further include STAs 906 and 908 associated with AP 902, and a STA 910 associated with AP 904.

As shown in FIG. 9, multi-AP uplink data transmission phase 900 may include frame exchanges to enable master AP 902 to coordinate with slave AP 904 to perform specific multi-AP transmission schemes with STAs 906, 908, and 910910. The multi-AP transmission schemes may include COFDMA, CTDMA, CSR, CBF, JT/JR, or a combination of two or more of the aforementioned schemes.

As shown in FIG. 9, master AP 902 may begin phase 900 by transmitting a frame 912 to AP 904. Frame 912 may include information related to AP 904 (e.g., an identifier of AP 904), synchronization information, information related to a specific multi-AP transmission scheme to be used, and/or information related to an RU for use by AP 904 to acknowledge frame 912. Frame 912 may comprise a control frame. For example, frame 912 may comprise a multi-AP trigger frame.

Slave AP 904 may receive frame 912 and may use the synchronization information to synchronize with master AP 902. Subsequently, APs 902 and 904 may solicit uplink data transmissions from their associated STAs 906, 908 and 910 using trigger frames. Specifically, AP 902 may transmit a trigger frame 914 to its associated STAs 906 and 908, and AP 904 may transmit a trigger frame 916 to its associated STA 910. Depending on the multi-AP transmission scheme being used, APs 902 and 904 may also transmit frames 914 and 916 respectively to STAs in different BSSs. For example, when the multi-AP transmission scheme is JT/JR, AP 902 may also transmit frame 914 to STA 910 associated with slave AP 904, and AP 904 may also transmit frame 916 to STAs 906 and 908 associated with AP 902. The resources for transmitting and receiving frames 914 and 916 may depend on the specific multi-AP transmission scheme adopted.

STAs 906 and 908 may respond to frame 914, STA 910 may respond to frame 916. For example, STAs 906 and 908 may transmit frames 918 and 920 respectively to AP 902, while STA 910 may transmit a frame 922 to AP 904. Frames 918, 920, and/or 922 may be transmitted simultaneously. Frames 918, 920, and 922 may comprise data frames or null data frames. STAs 906, 908, and 910 may also transmit frames 918, 920, and 922 respectively to APs in different BSSs, when required by the used multi-AP transmission scheme. For example, when the multi-AP transmission scheme is JT/JR, STAs 906 and 908 may also transmit respective frames 918 and 920 to AP 904, and STA 910 may also transmit frame 922 to AP 902. The resources for transmitting and receiving frames 918, 920, and 922 may depend on the specific multi-AP transmission scheme adopted.

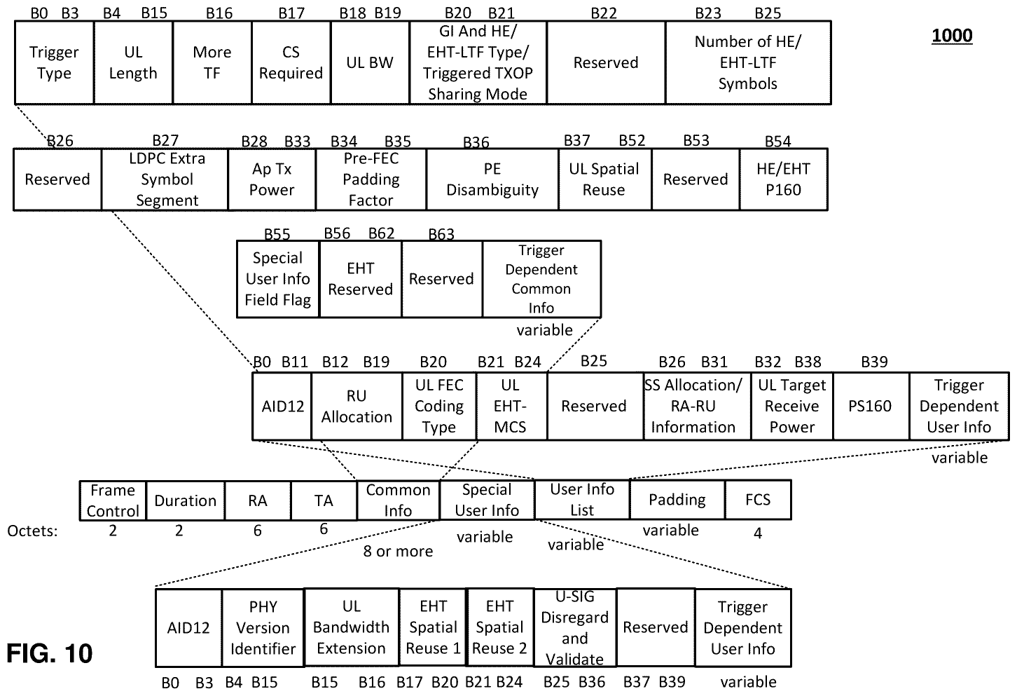

FIG. 10 illustrates an example trigger frame 1000. Trigger frame 1000 may correspond to a basic trigger frame as defined in the existing IEEE 802.11be standard amendment. Trigger frame 1000 may be used by an AP to allocate resources for and solicit one or more trigger-based (TB) PPDU transmissions from one or more STAs.

As shown in FIG. 10, trigger frame 1000 includes a Frame Control field, a Duration field, a receiver address (RA) field, a transmitter address (TA) field, a Common Info field, a Special User Info field, a User Info field, a Padding field, and an FCS field. The fields from the Frame Control field up to the TA field form a MAC header. The fields from the Common Info field up to the User Info List field form a MAC body.

The Frame Control field includes the following subfields (not shown in FIG. 10): protocol version, type, subtype, To DS, From DS, more fragments, retry, power management, more data, protected frame, and +HTC which may be used by a receiving STA to classify trigger frame 1000 as a trigger frame (TF).

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a receiving STA to update a network allocation vector (NAV). The NAV is a counter that it indicates to a STA an amount of time during which it must defer from accessing the shared medium.

The RA field is the address of the STA that is intended to receive the incoming transmission from the transmitting station. The TA field is the address of the STA transmitting trigger frame 1000 if trigger frame 1000 is addressed to STAs that belong to a single BSS. The TA field is the transmitted BSSID if the trigger frame 1000 is addressed to STAs from at least two different BSSs of the multiple BSSID set.

The RA field may contain an individual MAC address value to specify a single receiving STA of trigger frame 1000 or a broadcast address in case trigger frame 1000 is intended for multiple receiving STAs. The TA field may contain the address of the AP STA transmitting trigger frame 1000.

The Common Info field specifies a trigger frame type of trigger frame 1000, a transmit power of trigger frame 1000 in dBm (in AP Tx Power field), and several key parameters of a TB PPDU that is transmitted by a STA in response to trigger frame 1000. The trigger frame type of a trigger frame used by an AP to receive QoS data using UL MU operation is referred to as a basic trigger frame.

The Common Info field is a variable size field containing information regarding the solicited TB PPDU. The information contained in Common Info field is common to all STAs targeted by trigger frame 1000. The information may include a Trigger Type, a length, and a bandwidth of the solicited TB PPDU.

Similar to the Common Info field, the Special User Info field may also contain information that is common to all STAs targeted by trigger frame 1000. The Special User Info field is a User Info field that does not carry the user specific information but carries the extended common information not provided in the Common Info field. As shown in FIG. 10, this information may include an AID12 subfield, a PHY Version Identifier subfield, a UL Bandwidth subfield, an EHT Spatial Reuse 1 subfield, an EHT Spatial Reuse 2 subfield, a U-SIG Disregard and Validate subfield, a Reserved subfield, and a Trigger Dependent User Info subfield.

The AID12 subfield in the Special User Info field may be set to a fixed value of 2007 to differentiate the Special User Info field from a STA specific User Info field in the User Info List field. The PHY Version Identifier subfield indicates the PHY version of the solicited TB PPDU. The PHY Version Identifier subfield may be set to 0 for EHT PHY and to a non-zero value for future post-EHT PHY versions (e.g., NG PHY). The UL Bandwidth Extension subfield may include additional BW bits to support EHT TB PPDU bandwidths up to 320 MHz. The EHT Spatial Reuse 1 and 2 subfields carry values to be included in corresponding Spatial Reuse subfields in the U-SIG field of the solicited EHT TB PPDU. The U-SIG Disregard And Validate subfield carries a value to be included in corresponding Disregard and Validate subfields of the U-SIG field of the solicited EHT TB PPDU. The Reserved subfield is currently unused but may serve a purpose in future versions of the standard. The Trigger Dependent User Info subfield may be used to carry additional signaling information depending on the type of TF. Its size is variable and may not exist in some TF types.

The User Info field contains a User Info field per STA addressed in trigger frame 1000. The per STA User Info field includes, among others, an AID subfield, an RU Allocation subfield, a Spatial Stream (SS) Allocation subfield, an MCS subfield to be used by a STA in a TB PPDU transmitted in response to trigger frame 1000, an UL Target Receive Power subfield, and a Trigger Dependent User Info subfield. The UL Target Receive Power subfield indicates a target receive power at the AP of a TB PPDU transmitted by the STA. The Trigger Dependent User Info subfield i can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 1000 to extend the frame length to give recipient STAs enough time to prepare a response for transmission one short interframe space (SIFS) after the frame is received. To align the end time of simultaneously transmitted PPDUs on an NSTR link pair. The Padding field, if present, is at least two octets in length and is set to all 1s.

The FCS field is used by a STA to validate a received frame and to interpret certain fields from the MAC headers of a frame.

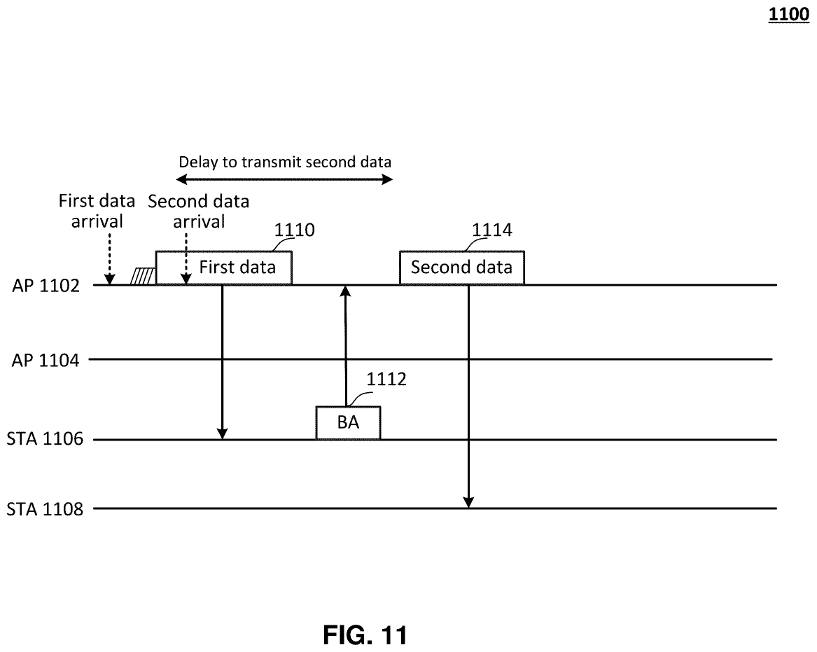

FIG. 11 is an example 1100 that illustrates a potential problem that may arise in a multi-AP environment. As shown in FIG. 11, example 1100 includes APs 1102 and 1104 and STAs 1106 and 1108. STAs 1106 and 1108 may be associated with AP 1102. APs 1102 and 1104 may be part of a coordinated AP set as described above in FIG. 6. In an example, AP 1102 may be a master AP of the coordinated AP set, and AP 1104 may be a slave AP of the coordinated AP set.

In example 1100, AP 1102 may have first data arrive for transmission to STA 1106. In an example, the first data may be associated with non-low latency traffic. Non-low latency traffic may comprise traffic that does not comprise any medium access control service data unit (MSDU) associated with one or more low latency traffic identifiers (TIDs). Low latency TIDs comprise TIDs associated with one or more predetermined traffic categories (e.g., voice/video). In example 1100, AP 1102 may proceed with transmitting the first data in a first data frame 1110 to STA 1106.

While transmitting first data frame 1110, AP 1102 may have second data arrive for transmission to STA 1108. In an example, the second data may be associated with low latency traffic. Low latency traffic may comprise traffic that comprises at least one MSDU associated with one or more low latency TIDs. Low latency TIDs comprise TIDs associated with one or more predetermined traffic categories. As AP 1102 is busy transmitting first data frame 1110 when the second data arrives, AP 1102 may not proceed to immediate transmission of the second data to STA 1108. Instead, as shown in FIG. 11, AP 1102 may need to wait for the transmission of first data frame 1110 and the reception of a BlockAck (BA) frame 1112 from STA 1106, before it may transmit the second data in a second data frame 1114 to STA 1208. As such, the transmission of the second data, which may comprise low latency traffic, may be delayed, and second data frame 1114 may be discarded when received by STA 1108.

Embodiments of the present disclosure, as further described below, address the above-described problem. In one aspect, embodiments enable an AP to offload to another AP the transmission of traffic to a target STA. In an example, the AP may offload to the other AP traffic of a first category instead of transmitting it itself to a target STA. The first category may comprise non-low latency traffic. The AP may thus free itself to transmit traffic of a second category immediately upon arrival. As such, the latency of the traffic of the second category may be reduced. The traffic of the second category may comprise low latency traffic. In another aspect, embodiments enable the AP to transmit the traffic of the second category concurrently with the transmission of the traffic of the first category by the other AP. Accordingly, spectrum utilization efficiency may be enhanced.

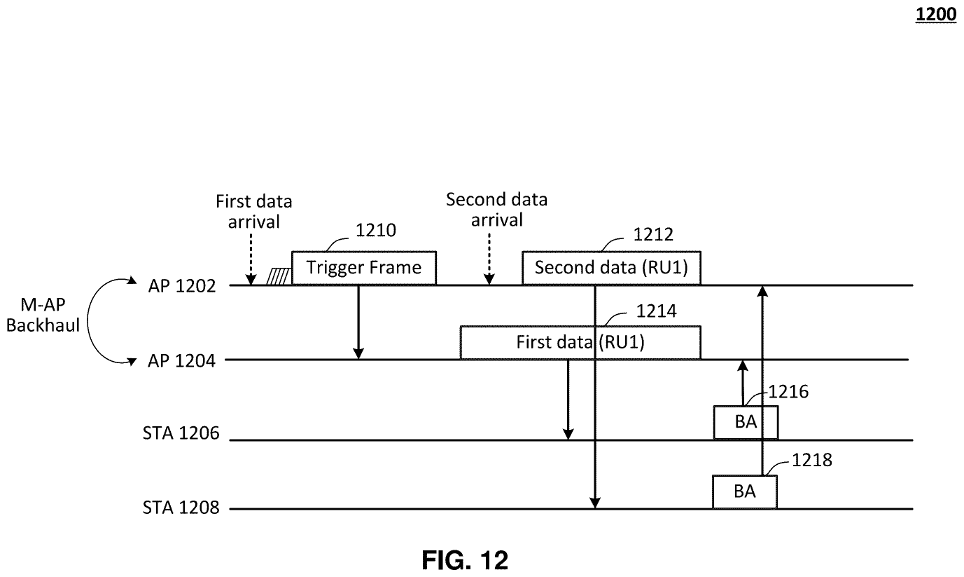

FIG. 12 is an example 1200 of a multi-AP offloading scheme according to an embodiment. As shown in FIG. 12, example 1200 includes APs 1202 and 1204 and STAs 1206 and 1208. STAs 1206 and 1208 may be associated with AP 1202. APs 1202 and 1204 may be part of a coordinated AP set as described above in FIG. 6. In an example, AP 1202 may be a master AP of the coordinated AP set, and AP 1204 may be a slave AP of the coordinated AP set. In an example, APs 1202 and 1204 may be connected via a backhaul link. The backhaul link may be wired or wireless.

In example 1200, AP 1202 may have first data arrive for transmission to STA 1206. In an embodiment, the first data is of a first category. The first category may comprise non-low latency traffic. Non-low latency traffic may comprise traffic that does not comprise any MSDU associated with one or more low latency TIDs. Low latency TIDs comprise TIDs associated with one or more predetermined traffic categories (e.g., voice/video).

In an embodiment, on receiving the first data of the first category, AP 1202 may choose to offload to AP 1204 the transmission of the first data to STA 1206. In an embodiment, the choice to offload data of the first category to AP 1204 may be based on AP 1202 expecting to receive data of a second category for transmission. The second category may comprise low latency traffic. For example, AP 1202 may expect to receive data of the second category for transmission to STA 1208. For example, AP 1202 may have received from STA 1208 a frame indicating presence of a traffic stream of the second category at STA 1208. In an embodiment, the frame may comprise a target wake time (TWT) element indicating the presence of the traffic stream of the second category at STA 1208. For example, the frame may comprise a TWT setup request frame. In another embodiment, the frame may comprise a Quality of Service (QOS) characteristics element indicating the presence of the traffic stream of the second category at STA 1208. The frame may comprise an action frame or a management frame.

In an embodiment, AP 1202 may forward the first data to AP 1204 via the backhaul link for transmission by AP 1204 to STA 1206.

In an embodiment, as shown in FIG. 12, AP 1202 may trigger AP 1204 to transmit the first data to STA 1206. In an embodiment, AP 1202 may transmit a trigger frame 1210 to AP 1204 to trigger AP 1204 to transmit a PPDU 1214 comprising the first data. In an embodiment, AP 1202 may include in trigger frame 1210 an indication of a resource unit (RU) for the transmission of PPDU 1214 by AP 1204. In another embodiment, trigger frame 1210 may include an indication of a transmission time of PPDU 1214. In an embodiment, when trigger frame 1210 does not include an indication of a transmission time of PPDU 1214, AP 1204 may transmit PPDU 1214 a SIFS after receiving trigger frame 1210. In an embodiment, trigger frame 1210 may further include a transmit power to be used by AP 1204 (or a maximum transmit that can be used by AP 1204) to transmit PPDU 1214.

In example 1200, after transmitting trigger frame 1210 to AP 1204, AP 1202 may have second data arrive for transmission to STA 1208. In an embodiment, the second data is of the second category. The second category may comprise low latency traffic. Low latency traffic may comprise traffic that comprises at least one MSDU associated with one or more low latency TIDs. Low latency TIDs comprise TIDs associated with one or more predetermined traffic categories (e.g., voice/video). In an example, the second data may arrive at AP 1202 before or during transmission of PPDU 1214 by AP 1204.

As AP 1202 has offloaded the first data to AP 1204, AP 1202 is available to transmit the second data to STA 1208 immediately on its arrival at AP 1202. As such, as shown in FIG. 12, AP 1202 may transmit the second data, without delay, to STA 1208 via a PPDU 1212. In an example, PPDU 1212 may overlap PPDU 1214 transmitted by AP 1204. That is, PPDU 1212 may overlap in time and frequency, partially or fully, with PPDU 1214. In an embodiment, AP 1202 may transmit PPDU 1212, overlapping PPDU 1214, based on the second data being of the second category.

In an embodiment, AP 1202 may transmit PPDU 1212, overlapping PPDU 1214, using spatial reuse. The spatial reuse may include coordinated spatial reuse (CSR) as described above in FIG. 5. In an example, APs 1202 and 1204 may perform a path loss measurement procedure (e.g., joint sounding) to measure path loss to and from each other and/or to and from OBSS STAs. Using the path loss information, AP 1202 computes a maximum transmit power that AP 1204 may use to transmit PPDU 1214. In an embodiment, AP 1202 may set the maximum transmit power for PPDU 1214 such that PPDU 1212 is received successfully by STA 1208 when PPDU 1212 is transmitted in an overlapping manner (overlapping in time and frequency) over PPDU 1214. Specifically, to allow STA 1208 to receive PPDU 1212 with a sufficient SIR margin, a maximum transmit power of AP 1204 for PPDU 1214 must be set based on the PL from AP 1204 to STA 1208. For example, if a maximum interference level of X is required for PPDU 1212 at STA 1208, AP 1202 may calculate the maximum transmit power, TxAP2pwr, of AP 1204 for PPDU 1214 as equal to (X+PL), where PL is the path loss from AP 1204 to STA 1208. The PL from AP 1204 to STA 1208 may be obtained during the path loss measurement procedure.

PPDUs 1212 and 1214 may be acknowledged by STAs 1208 and 1206, respectively, with acknowledgment frames 1218 and 1216, respectively. Acknowledgment frames 1216 and 1218 may comprise BA frames.

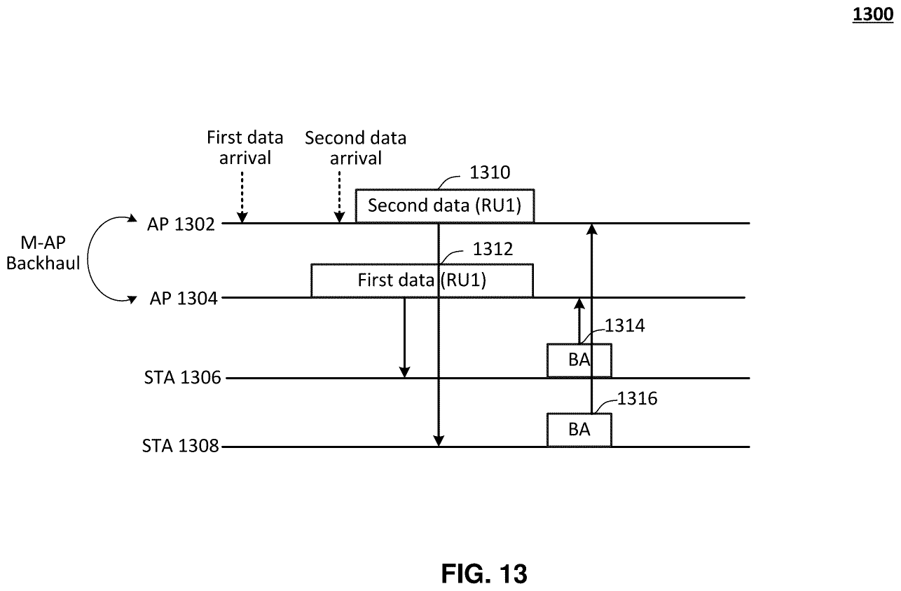

FIG. 13 is an example 1300 of another multi-AP offloading scheme according to an embodiment. As shown in FIG. 13, example 1300 includes APs 1302 and 1304 and STAs 1306 and 1308. STAs 1306 and 1308 may be associated with AP 1302. APs 1302 and 1304 may be part of a coordinated AP set as described above in FIG. 6. In an example, AP 1302 may be a master AP of the coordinated AP set, and AP 1304 may be a slave AP of the coordinated AP set. In an example, APs 1302 and 1304 may be connected via a backhaul link. The backhaul link may be wired or wireless.

In example 1300, AP 1302 may have the first data arrive for transmission to STA 1306. In an embodiment, the first data is of a first category. The first category may comprise non-low latency traffic. Non-low latency traffic may comprise traffic that does not comprise any MSDU associated with one or more low latency TIDs. Low latency TIDs comprise TIDs associated with one or more predetermined traffic categories (e.g., voice/video).

In an embodiment, on receiving the first data of the first category, AP 1302 may choose to offload to AP 1304 the transmission of the first data to STA 1306. In an embodiment, the choice to offload data of the first category to AP 1304 may be based on AP 1302 expecting to receive data of a second category for transmission. The second category may comprise low latency traffic. Low latency traffic may comprise traffic that comprises at least one MSDU associated with one or more low latency TIDs. Low latency TIDs comprise TIDs associated with one or more predetermined traffic categories (e.g., voice/video). For example, AP 1302 may expect to receive data of the second category for transmission to STA 1308. For example, AP 1302 may have received from STA 1308 a frame indicating presence of a traffic stream of the second category at STA 1308. In an embodiment, the frame may comprise a TWT element indicating the presence of the traffic stream of the second category at STA 1308. For example, the frame may comprise a TWT setup request frame. In another embodiment, the frame may comprise a QoS characteristics element indicating the presence of the traffic stream of the second category at STA 1308. The frame may comprise an action frame or a management frame.

In an embodiment, AP 1302 may forward the first data to AP 1304 via the backhaul link for transmission by AP 1304 to STA 1306.

In an embodiment, AP 1302 may send an indication to AP 1304 to transmit the first data to STA 1306 via the backhaul link. In an embodiment, the indication may comprise an indication of an RU for the transmission of a PPDU 1312 comprising the first data by AP 1304. In another embodiment, the indication may comprise an indication of a transmission time of PPDU 1312. In an embodiment, when the indication does not include an indication of a transmission time of PPDU 1312, AP 1304 may transmit PPDU 1312 immediately on receiving the indication from AP 1302. In an embodiment, the indication may further include a transmit power to be used by AP 1304 (or a maximum transmit that can be used by AP 1304) to transmit PPDU 1312. The sending of AP 1302 of the indication to AP 1304 via the backhaul eliminates the need to transmit a trigger frame via the wireless medium as in FIG. 12. This may help keep AP 1302 free for any subsequently arriving traffic, such as low latency traffic.

In example 1300, after transmitting the indication to AP 1304 via the backhaul link, AP 1302 may have second data arrive for transmission to STA 1308. In an embodiment, the second data is of the second category. The second category may comprise low latency traffic. Low latency traffic may comprise traffic that comprises at least one MSDU associated with one or more low latency TIDs. Low latency TIDs comprise TIDs associated with one or more predetermined traffic categories (e.g., voice/video). In an example, the second data may arrive at AP 1302 before or during transmission of PPDU 1312 by AP 1304.

As AP 1302 has offloaded the first data to AP 1304, AP 1302 is available to transmit the second data to STA 1308 immediately on its arrival at AP 1302. As such, as shown in FIG. 13, AP 1302 may transmit the second data, without delay, to STA 1308 via a PPDU 1310. In an example, PPDU 1310 may overlap PPDU 1312 transmitted by AP 1304. That is, PPDU 1310 may overlap in time and frequency, partially or fully, with PPDU 1312. In an embodiment, AP 1302 may transmit PPDU 1310, overlapping PPDU 1312, based on the second data being of the second category.

In an embodiment, AP 1302 may transmit PPDU 1310, overlapping PPDU 1312, using spatial reuse. The spatial reuse may include CSR as described above in FIG. 5. In an example, APs 1302 and 1304 may perform a path loss measurement procedure (e.g., joint sounding) to measure path loss to and from each other and/or to and from OBSS STAs. Using the path loss information, AP 1302 computes a maximum transmit power that AP 1304 may use to transmit PPDU 1312. In an embodiment, AP 1302 may set the maximum transmit power for PPDU 1312 such that PPDU 1310 is received successfully by STA 1308 when PPDU 1310 is transmitted in an overlapping manner (overlapping in time and frequency) over PPDU 1312. Specifically, to allow STA 1308 to receive PPDU 1310 with a sufficient SIR margin, a maximum transmit power of AP 1304 for PPDU 1312 must be set based on the PL from AP 1304 to STA 1308. For example, if a maximum interference level of X is required for PPDU 1310 at STA 1308, AP 1302 may calculate the maximum transmit power, TxAP2pwr, of AP 1304 for PPDU 1312 as equal to (X+PL), where PL is the path loss from AP 1304 to STA 1308. The PL from AP 1304 to STA 1308 may be obtained during the path loss measurement procedure.

PPDUs 1310 and 1312 may be acknowledged by STAs 1308 and 1306, respectively, with acknowledgment frames 1316 and 1314, respectively. Acknowledgment frames 1314 and 1316 may comprise BA frames.

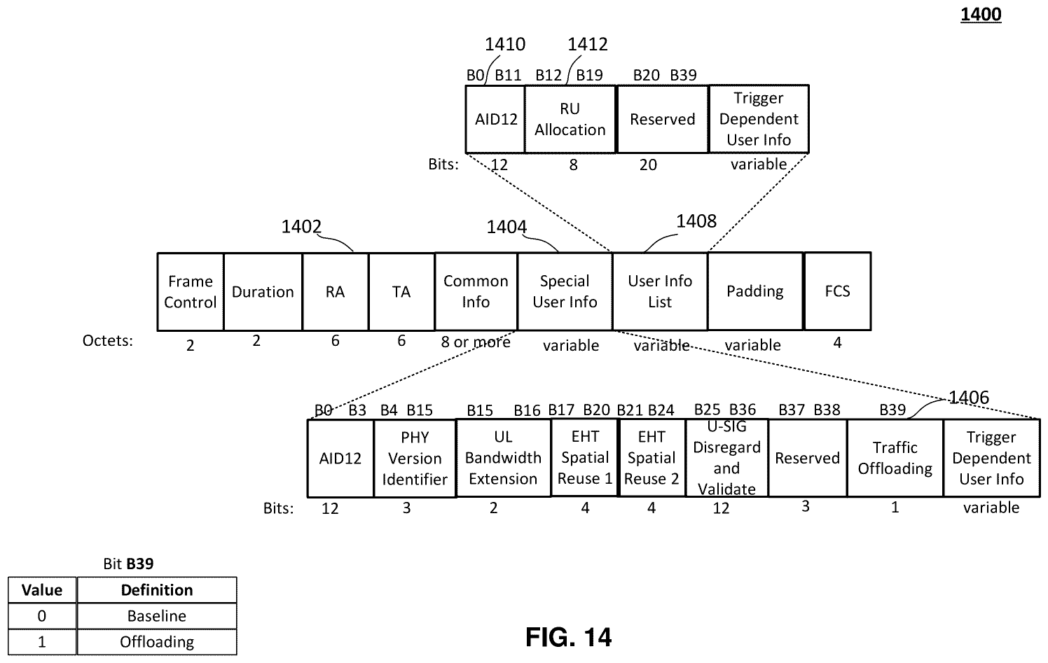

FIG. 14 illustrates an example trigger frame 1400 according to an embodiment. Example trigger frame 1400 is provided for the purpose of illustration only and is not limiting of embodiments. Example trigger frame 1400 may be an embodiment of trigger frame 1210 described above in FIG. 12 and may thus be transmitted by a first AP to a second AP.

As shown in FIG. 14, example trigger frame 1400 may be a modified version of trigger frame 1000 described above in FIG. 10. Specifically, trigger frame 1400 may include a modified RA field 1402, a modified special user info field 1404, and/or a modified user info field 1408.

In an embodiment, RA field 1402 may be adapted to include the address of a second AP to which traffic is being offloaded by the first AP. For example, with reference to FIG. 12, AP 1202 may indicate in RA field 1402 the address of AP 1204.

Special User info field 1404 may include a traffic offloading subfield 1406 in bit 39 (B39). Traffic offloading subfield 1406 may thus replace a reserved bit of the special user info field of trigger frame 1000. In an embodiment, the traffic offloading subfield 1406 may carry an indication of whether an offloading mode is enabled. In an embodiment, traffic offloading subfield 1406 takes a value of 1 to indicate that the offloading mode is enabled and a value of 0 to indicate that the offloading mode is disabled. In an embodiment, when the offloading mode is enabled, it indicates that the first AP is offloading to the second AP traffic for transmission by the second AP to a STA associated with the first AP.

In an embodiment, when the offloading mode is enabled, trigger frame 1400 may include modified user info field 1408. In an embodiment, an AID12 field 1410 of user info field 1408 indicates the destination STA of the offloaded traffic. RU allocation field 1412 of user info field 1408 may indicate an RU for use by the second AP to transmit the offloaded traffic to the destination STA. For example, with reference to FIG. 12, when the offloading mode is enabled, AID12 field 1410 may indicate an address of STA 1206 and RU allocation field 1412 may indicate RU1.

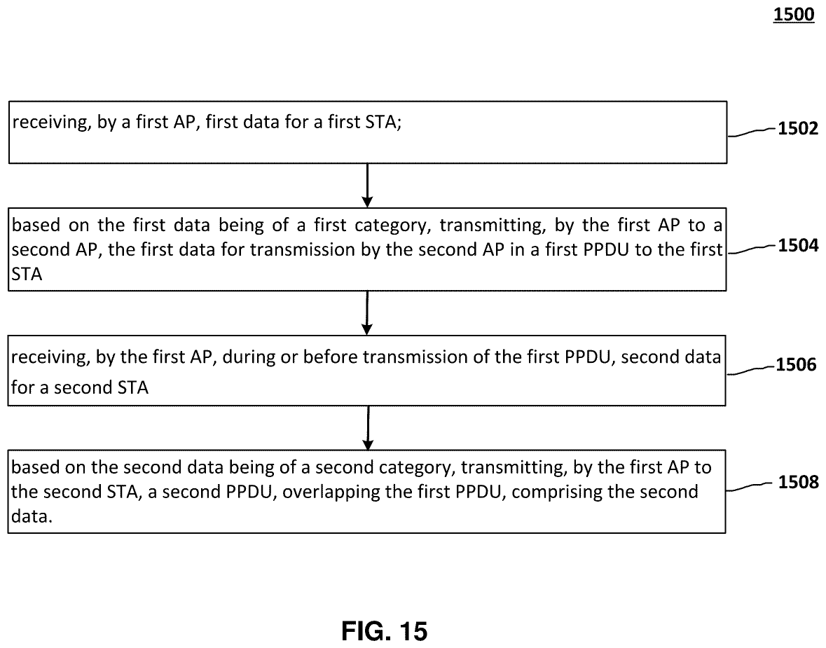

FIG. 15 illustrates an example process 1500 according to an embodiment. Example process 1500 is provided for the purpose of illustration only and is not limiting. Example process 1500 may be performed by a first AP, such as AP 1202 or AP 1302.

As shown in FIG. 15, process 1500 may begin in step 1502, which includes receiving, by the first AP, first data for a first STA. The first STA may be a STA associated with the first AP. The first data may include data of a first category. The first category may comprise non-low latency traffic. Non-low latency traffic may comprise traffic that does not comprise any MSDU associated with one or more low latency TIDs. Low latency TIDs comprise TIDs associated with one or more predetermined traffic categories (e.g., voice/video).

Step 1504 may include transmitting, by the first AP to a second AP, the first data for transmission by the second AP in a first PPDU to the first STA. In an embodiment, the first AP and the second AP form a coordinated AP set. In an embodiment, the first AP is a master AP and the second AP is a slave AP of the coordinated AP set.

In an embodiment, the transmitting, by the first AP to the second AP, of the first data is based on the first data being of the first category. In an embodiment, the first AP may transmit the first data to the second AP via a backhaul link. The backhaul link may comprise a wireless link or a wired link.

In an embodiment, process 1500 may further comprise transmitting, by the first AP to the second AP, a transmit power for use in transmission of the first PPDU to the first STA (or a maximum transmit that can be used by the second to transmit the first PPDU). In an embodiment, process 1500 may further comprise transmitting, by the first AP to the second AP, an indication of a transmission time of first PPDU. In an embodiment, process 1500 may further comprise transmitting, by the first AP to the second AP, an indication of an RU for the transmission of the first PPDU.

In an embodiment, process 1500 may further comprise transmitting, by the first AP to the second AP, a trigger frame triggering transmission by the second AP of the first PPDU to the first STA.

Step 1506 may include receiving, by the first AP, during or before transmission of the first PPDU, second data for a second STA.

Step 1508 may include transmitting, by the first AP to the second STA, a second PPDU, overlapping the first PPDU, comprising the second data. In an embodiment, the second PPDU overlaps the first PPDU in time and frequency. In an embodiment, transmitting the second PPDU comprises transmitting the second PPDU using spatial reuse. The spatial reuse may comprise CSR.

In an embodiment, the transmitting, by the first AP to the second STA of the second PPDU is based on the second data being of a second category. That is, the first AP transmits the second PPDU, overlapping the first PPDU, based on the second data being of the second category. In an embodiment, the second category may comprise low latency traffic. Low latency traffic may comprise traffic that comprises at least one MSDU associated with one or more low latency TIDs. Low latency TIDs comprise TIDs associated with one or more predetermined traffic categories (e.g., voice/video). In an embodiment, the transmitting, by the first AP to the second STA, of the second PPDU is based on the second data being of a second category and the first data being of the first category.

In an embodiment, process 1500 may further comprise receiving, by the first AP from the second STA, a frame indicating the presence of a traffic stream of the second category at the second STA. In an embodiment, the frame comprises a TWT element indicating the presence of the traffic stream of the second category at the second STA. The frame may comprise a TWT setup request frame. In another embodiment, the frame comprises a QoS characteristics element indicating the presence of the traffic stream of the second category at the second STA. The frame may comprise an action frame or a management frame.

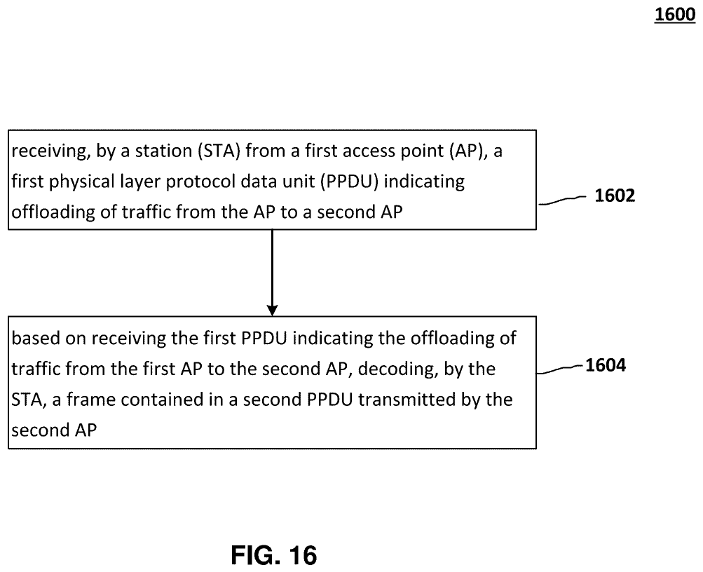

FIG. 16 illustrates an example process 1600 according to an embodiment. Example process 1600 is provided for the purpose of illustration only and is not limiting. Example process 1600 may be performed by a non-AP STA, such as STA 1206 or STA 1306.

As shown in FIG. 16, process 1600 may begin in step 1602, which includes receiving, by a STA from a first AP, a first PPDU indicating offloading of traffic from the first AP to a second AP.

In an embodiment, the STA is associated with the first AP. In an embodiment, the second AP comprises an OBSS AP with which the STA is not associated. In an embodiment, the first AP and the second AP are part of a coordinated AP set.

In an embodiment, the first PPDU may comprise a trigger frame. In an embodiment, an RA field of the trigger frame comprises an address of the second AP. In an embodiment, a user info field of the trigger frame comprises an address of the STA.

Step 1604 may include, based on receiving the first PPDU indicating the offloading of traffic from the first AP to the second AP, decoding, by the STA, a frame contained in a second PPDU transmitted by the second AP. In an embodiment, the frame contained in the second PPDU comprises data for the STA offloaded by the first AP to the second AP. As such, the STA receives the offloaded data from the second STA with which it is not associated.

In an embodiment, the decoding, by the STA, of the frame contained in the second PPDU may be further based on the first PPDU indicate the address of the second AP and/or the address of the STA.

In an embodiment, the offloading of traffic is based on the traffic being of a first category. In this embodiment, the first category comprises non-low latency traffic. Non-low latency traffic may comprise traffic that does not comprise any MSDU associated with one or more low latency TIDs.

In an embodiment, process 1600 may further comprise transmitting, by the STA to the second AP, a third PPDU comprising a BA frame when a receiver address of the frame in the second PPDU is equal to an address of the STA.

1. A first access point (AP) comprising:
one or more processors; and
memory storing instructions that, when executed by the one or more processors, cause the first AP to:
receive first data for a first station (STA);
transmitting, to a second AP, the first data for transmission by the second AP in a first PPDU to the first STA;
receive, during or before transmission of the first PPDU, second data for a second STA; and
transmit, to the second STA, a second PPDU, overlapping the first PPDU, comprising the second data.

2. The first AP of claim 1, wherein the instructions, when executed by the one or more processors, further cause the first AP to transmit, to the second AP, the first data based on the first data being of a first category.

3. The first AP of claim 2, wherein the first category comprises non-low latency traffic.

4. The first AP of claim 1, wherein the instructions, when executed by the one or more processors, further cause the first AP to transmit, to the second STA, the second PPDU based on the second data being of a second category.

5. The first AP of claim 4, wherein the second category comprises low latency traffic.

6. The first AP of claim 4, wherein the instructions, when executed by the one or more processors, further cause the first AP to receive, from the second STA, a frame indicating a presence of a traffic stream of the second category at the second STA.

7. The first AP of claim 6, wherein the frame comprises a target wake time (TWT) element indicating a presence of the traffic stream of the second category at the second STA.

8. The first AP of claim 6, wherein the frame comprises a Quality of Service (QOS) characteristics element indicating a presence of the traffic stream of the second category at the second STA.

9. The first AP of claim 1, wherein the instructions, when executed by the one or more processors, further cause the first AP to transmit, to the second AP, a trigger frame triggering transmission by the second AP of the first PPDU to the first STA.

10. The first AP of claim 1, wherein the instructions, when executed by the one or more processors, further cause the first AP to transmit the first data for transmission by the second AP via a backhaul link between the first AP and the second AP.

11. The first AP of claim 1, wherein the instructions, when executed by the one or more processors, further cause the first AP to transmit the second PPDU using spatial reuse.

12. The first AP of claim 1, wherein the instructions, when executed by the one or more processors, further cause the first AP to transmit, to the second AP, a transmit power for use in transmission of the first PPDU to the first STA.

13. The first AP of claim 1, wherein the first AP is a master AP and the second AP is a slave AP.

14. A station (STA) comprising:
one or more processors; and
memory storing instructions that, when executed by the one or more processors, cause the STA to:
receive, from a first access point (AP), a first physical layer protocol data unit (PPDU) indicating offloading of traffic from the first AP to a second AP; and
based on receiving the first PPDU indicating the offloading of traffic from the first AP to the second AP, decode a frame contained in a second PPDU transmitted by the second AP.

15. The STA of claim 14, wherein the STA is associated with the first AP, and wherein the second AP comprises an overlapping basic service set (OBSS) AP with which the STA is not associated.

16. The STA of claim 14, wherein the first PPDU comprises a trigger frame.

17. The STA of claim 16, wherein a receiver address (RA) field of the trigger frame comprises an address of the second AP, and wherein a user info field of the trigger frame comprises an address of the STA.

18. The STA of claim 14, wherein the instructions, when executed by the one or more processors, further cause the STA to transmit, to the second AP, a third PPDU comprising a BlockAck (BA) frame when a receiver address of the frame in the second PPDU is equal to an address of the STA.

19. The STA of claim 14, wherein the offloading of traffic from the first AP to the second AP is based on the traffic being of a first category.

20. A non-transitory computer-readable medium comprising instructions that, when executed by one or more processors of a first access point (AP), cause the first AP to:
receive first data for a first station (STA);
transmitting, to a second AP, the first data for transmission by the second AP in a first PPDU to the first STA;
receive, during or before transmission of the first PPDU, second data for a second STA; and
transmit, to the second STA, a second PPDU, overlapping the first PPDU, comprising the second data.
